(19) United States
(12) Patent Application Publication
(10) Pub. No.: US 2008/0256448 A1
(43) Pub. Date: Oct. 16, 2008

(54) Multi-Frame Video Display Method and Apparatus

(76) Inventor: Nikhil Mahesh Bhatt, Cupertino, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 11/735,466

(22) Filed: Apr. 14, 2007

(51) Int. Cl. G06F 3/00; G11B 27/00; H04N 5/93

(52) U.S. Cl. 715/716; 386/52; 386/54; 715/719

(57) ABSTRACT

Methods, graphical user interfaces, computer apparatus and computer readable medium for producing media content are disclosed. A user of a computing device can utilize the methods, graphical user interfaces, computer apparatus or computer readable medium to align audio content with video content. In one embodiment, a plurality of video frames can be concurrently displayed to facilitate alignment of audio content with respect to particular video frames of the video. The plurality of video frames can be displayed automatically or on-demand. Also, when the plurality of video frames are displayed, the position of the frames can be determined automatically or by user action.

### BACKGROUND OF THE INVENTION

1. Field of the Invention

The present invention relates to media production and, more particularly, to providing video display during audio production.

2. Description of the Related Art

In the course of producing a video, such as a movie, it is common for audio engineers (or sound engineers) to add audio tracks to a video track. This task can be referred to as audio production. It takes a substantial effort to place the audio tracks in the proper position with respect to the video track. Often, the audio tracks are overlapping such as to provide background noise, dialog, sound effects, etc. There are software programs that assist audio engineers with these tasks. One example of an existing software program for audio editing/production application is “Soundtrack Pro” available from Apple Inc. of Cupertino, Calif.

Unfortunately, however, properly aligning audio tracks, such as audio clips, with video tracks is a tedious process. For high quality results, accurate alignment is needed but can be difficult to acquire. As an example, if an audio clip to be placed is a sound effect, proper placement of the sound effect with respect to video frames that are associated with the sound effect is important to maintain realism of the video (e.g., movie). Conventionally, a video frame can be viewed in a video playback window, but the video playback window tends to be small, static and ill-positioned, and thus not well suited for aligning audio clips. Thus, there is a need for improved approaches to align audio tracks to a video track.

### SUMMARY OF THE INVENTION

The invention pertains to methods, graphical user interfaces, computer apparatus and computer readable medium for producing media content. A user of a computing device can utilize the methods, graphical user interfaces, computer apparatus or computer readable medium to align audio content with video content. In one embodiment, a plurality of video frames can be concurrently displayed to facilitate alignment of audio content with respect to particular video frames of the video. The plurality of video frames can be displayed automatically or on-demand. Also, when the plurality of video frames are displayed, the position of the frames can be determined automatically or by user action.

The invention can be implemented in numerous ways, including as a method, system, device, apparatus (including graphical user interface), or computer readable medium. Several embodiments of the invention are discussed below.

As a graphical user interface, one embodiment of the invention comprises: a timeline for a digital video asset including a series of video frames; at least one audio track region for associating one or more audio segments to the digital video asset; a first reference indicator related to the timeline for the digital video asset; a second reference indicator related to the timeline for the digital video asset; and a video frame overlay viewer configured to concurrently present a plurality of video frames. The video frames being presented can include at least a first video frame and a second video frame. The first video frame being a particular one of the video frames from the digital video asset that corresponds to the first reference indicator, and the second video frame being a particular one of the video frames from the digital video asset that corresponds to the second reference indicator.

As a method for displaying video frames of a digital video asset, one embodiment of the invention includes at least: displaying a timeline for the digital video asset; displaying a first reference indicator on the timeline for the digital video asset; displaying a second reference indicator on the timeline for the digital video asset; and displaying a video frame overlay viewer having a plurality of video frames being displayed. The video frames include at least a first video frame and a second video frame. The first video frame being a particular one of the video frames from the digital video asset that corresponds to the first reference indicator, and the second video frame being a particular one of the video frames from the digital video asset that corresponds to the second reference indicator.

As a computer readable medium including at least computer program code for displaying video frames of a digital video asset, one embodiment of the invention includes at least: computer program code for displaying a timeline for the digital video asset; computer program code for displaying a first reference indicator on the timeline for the digital video asset; computer program code for displaying a second reference indicator on the timeline for the digital video asset; and computer program code for displaying a video frame overlay viewer having a plurality of video frames being displayed, where the video frames including at least a first video frame and a second video frame. The first video frame being a particular one of the video frames from the digital video asset that corresponds to the first reference indicator, and the second video frame being a particular one of the video frames from the digital video asset that corresponds to the second reference indicator.

As a computing apparatus, one embodiment of the invention includes at least: a display device capable of displaying a user interface; a data storage device configured to store a digital video asset; and a processing device operatively connected to the display device and the data storage device. The processing device can be configured to at least present a video frame overlay viewer having a plurality of video frames that are concurrently displayed. The video frames include at least a first video frame and a second video frame. The first video frame being a particular one of the video frames from the digital video asset that corresponds to a first reference indicator. The second video frame being a particular one of the video frames from the digital video asset that corresponds to a second reference indicator.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is an exemplary diagram of an audio association window according to one embodiment of the invention.

FIG. 2 is a diagram of a multipoint video pane according to one embodiment of the invention.

FIG. 3 is a flow diagram of a video frame review process according to one embodiment of the invention.

FIGS. 4A-4C are flow diagrams of an audio association process according to one embodiment of the invention.

FIG. 5 shows an exemplary computer system suitable for use with the invention.

### DETAILED DESCRIPTION OF THE INVENTION

The invention pertains to methods, graphical user interfaces, computer apparatus and computer readable medium for producing media content. More particularly, a user of a computing device can utilize the methods, graphical user interfaces, computer apparatus, or computer readable medium to align audio content with video content. In one embodiment, a plurality of video frames can be concurrently displayed to facilitate alignment of audio content with respect to particular video frames of the video. The plurality of video frames can be displayed automatically or on-demand. Also, when the plurality of video frames are displayed, the position of the frames can be determined automatically or by user action.

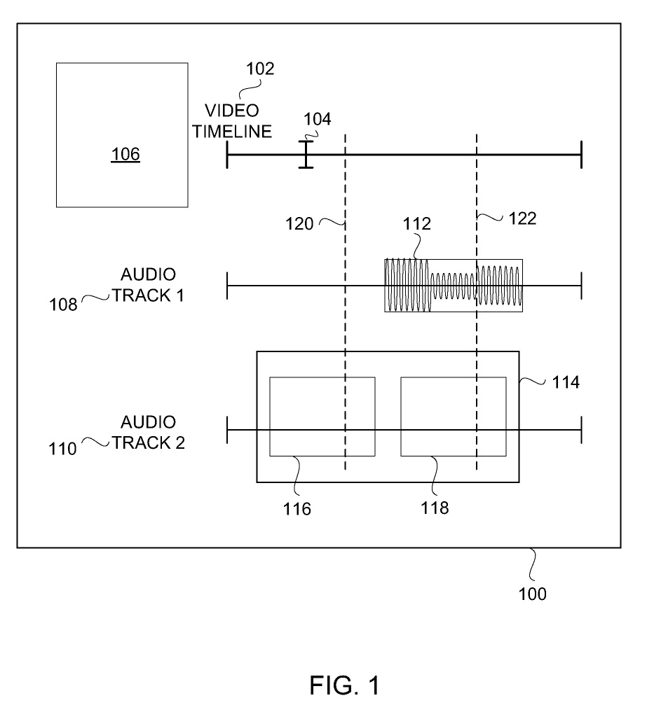

Embodiments of the invention are discussed below with reference to FIGS. 1-5. However, those skilled in the art will readily appreciate that the detailed description given herein with respect to these figures is for explanatory purposes as the invention extends beyond these limited embodiments.

FIG. 1 is an exemplary diagram of an audio association window 100 according to one embodiment of the invention. The audio association window 100 is a graphical user interface that is capable of being presented on a display device. Typically, the audio association window 100 is displayed on a display device associated with a computing device, such as a personal computer.

The audio association window 100 includes a video timeline 102 that is associated with a digital video asset. Examples of digital video assets include movies, music videos, etc. The video timeline 102 corresponds to the duration of the digital video asset. A play bar 104 can indicate the current play position with respect to the video timeline 102. The play bar 104 will slowly move to the right as the digital video asset is played. However, the user can move the play bar 104 to alter the play position. The video being produced by the digital video asset can be displayed in a playback window 106. The audio association window 100 typically includes various other controls presented to the user. These other controls enable the user to play, stop or otherwise manipulate the video playback.

The audio association window 100 is primarily configured to assist the user in associating one or more audio clips to the digital video asset. As illustrated in FIG. 1, the audio association window 100 can support multiple audio tracks, namely, audio track 1 (108) and audio track 2 (110). Placing of audio clips into one or more audio tracks can, for example, be performed with a drag and drop operation. For example, the audio association window 100 illustrates an audio clip 112 being placed within the audio track 1 (108). However, to assist the user in aligning the audio clip 112 with respect to the particular position of the digital video asset where the audio clip 112 is to be utilized. In this regard, a multipoint video pane 114 can be displayed on or within the audio association window 100. The multipoint video pane 114 includes a first video frame display region 116 and a second video frame display region 118. The first video display region 116 displays a frame of video from the digital video asset as designated by a first reference indicator 120. The second video display region 118 displays a frame of video from the digital video asset that corresponds to a second reference indicator 122. The multipoint video pane 114 thus assists the user in aligning the audio clip 112 with respect to the digital video asset. The user can not only move the audio clip 112 with respect to the first audio track 108, but can also move either or both of the first reference indicator 120 or the second reference indicator 122. When either of the reference indicators 120 or 122 is moved, the associated frame being presented in the first or second video display region 116 and 118 is altered to correspond to the associated reference indicator 120 and 122.

In one embodiment, the multipoint video pane 114 is partially translucent so that the multipoint video pane 114 can be utilized, e.g., displayed, over other graphical user interface components without completely obscuring such other user interface components (e.g., audio tracks, timelines, etc.). In this regard, the first video frame display region 116 and the second video frame display region 118 can also be partially translucent such that when displaying video frames other graphical user interface components need not be obscured.

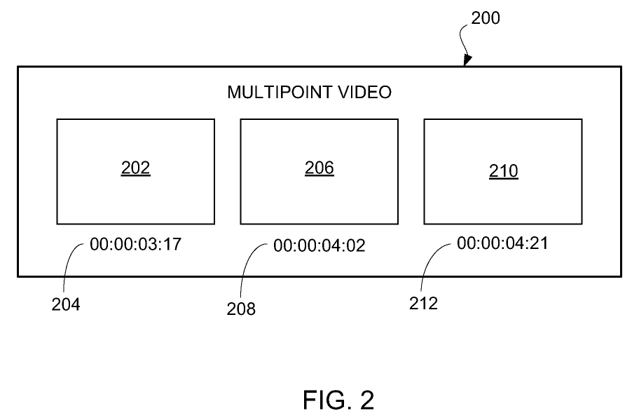

FIG. 2 is a diagram of a multipoint video pane 200 according to one embodiment of the invention. The multipoint video pane 200 is, for example, suitable for use as the multipoint video pane 114 illustrated in FIG. 1. The multipoint video pane 200 includes a first video display region 202 and a first metadata region 204. The first video display region 202 displays a particular video frame corresponding to a first reference indicator. The first metadata region 204 displays metadata corresponding to the particular video frame being displayed in the first video display region 202. In the example illustrated in FIG. 2, the metadata presented in the first metadata region 204 is a time code associated with the video position of the particular video frame being displayed in the first video display region 202. The multipoint video pane 200 also includes a second video display region 206 and a second metadata region 208. Still further, the multipoint video pane 200 includes a third video display region 210 and a third metadata region 212.

It should be noted that the metadata being displayed in the first metadata region 204, the second metadata region 208 or the third metadata region 212 can, in general, pertain to an attribute of the media. For example, the metadata is not limited to time codes but could alternatively or additionally pertain to other data, such as frame number.

Although the multipoint video pane 200 illustrated in FIG. 2 displays three separate video display regions 202, 206 and 210, it should be understand that the multipoint video pane can, in other embodiments, display more or less video display regions. Furthermore, although the video display regions 202, 206 and 210 illustrated in FIG. 2 are displayed in a horizontal arrangement, it should be understood that the video display regions 202, 206, and 210 could alternatively be provided in another organization, such as a vertical arrangement.

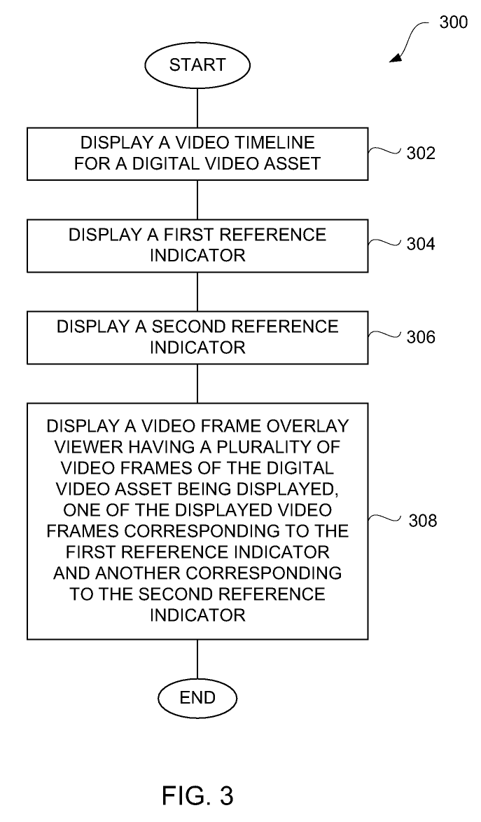

FIG. 3 is a flow diagram of a video frame review process 300 according to one embodiment of the invention. The video frame review process 300 is, for example, performed by a computer having an associated display device. The video frame review process 300 assists a user in locating particular frames within a digital video asset. As an example, the user can be locating particular frames within the digital video asset so as to position an audio element (e.g., audio clip) relative to the particular frames of the digital video asset.

The video frame review process 300 can display 302 a video timeline for a digital video asset. In addition, a first reference indicator can be displayed 304 and a second reference indicator can be displayed 306. In one implementation, the first and second reference indicators can be displayed 304, 306 in relation to the video timeline. In addition, a video frame overlay viewer can be displayed 308. The video frame overlay viewer is a graphical user interface component that can display a plurality of video frames of the digital video asset being reviewed. In one implementation, one of the video frames being displayed in the video frame overlay corresponds to the first reference indicator, and another of the video frames being displayed in the video frame overlay corresponds to the second reference indicator.

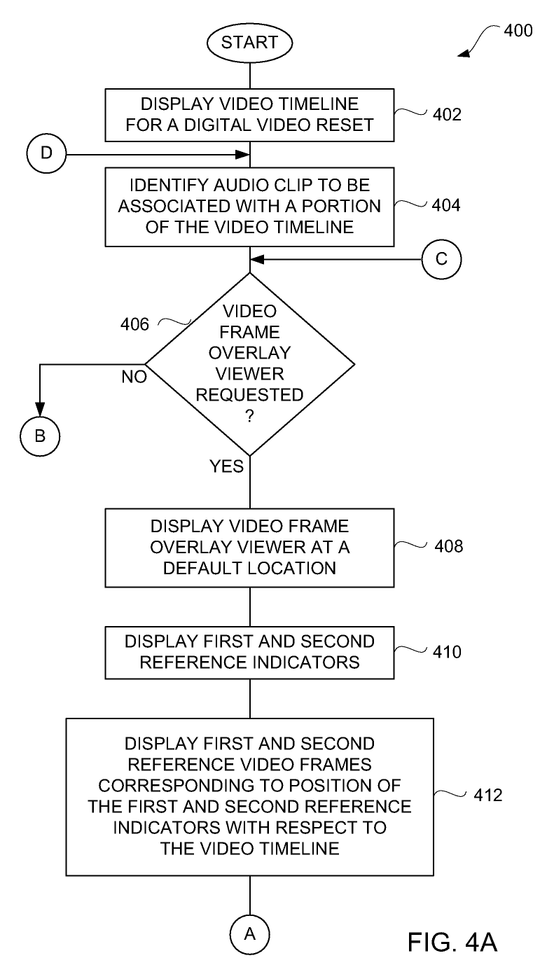

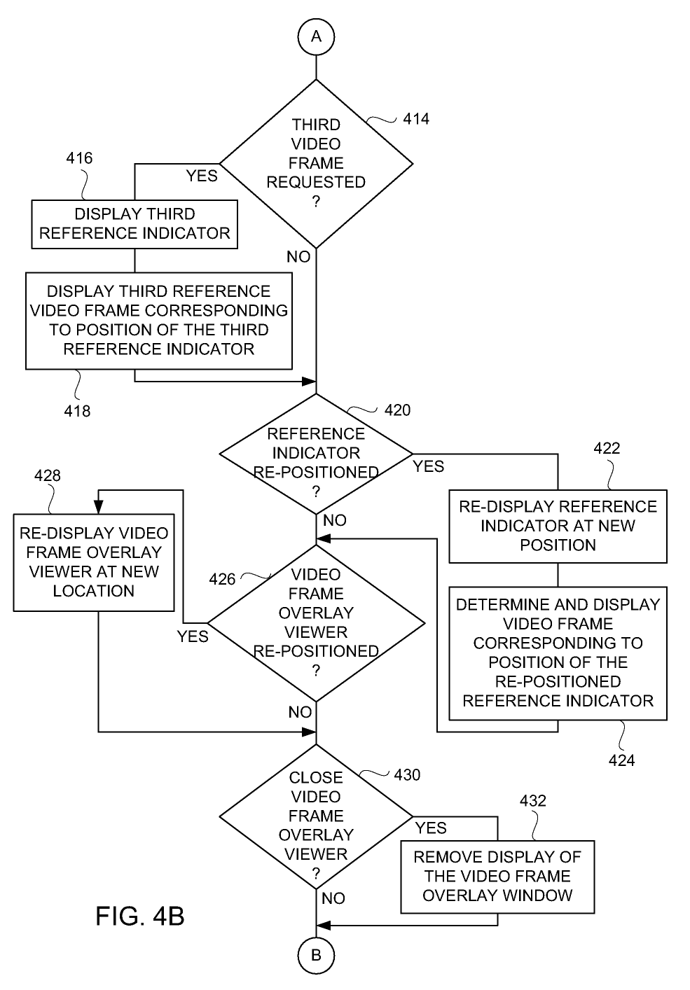

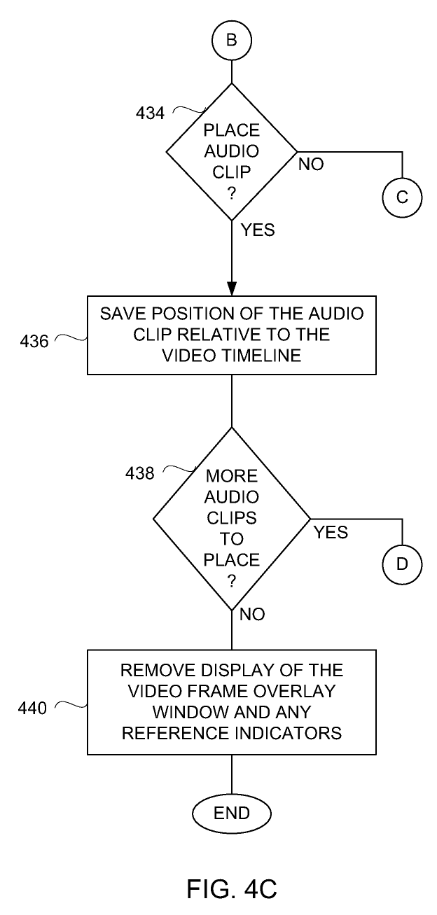

FIGS. 4A-4C are flow diagrams of an audio association process 400 according to one embodiment of the invention. The video frame review process 300 is, for example, performed by a computer having an associated display device. The audio association process 400 displays 402 a video timeline for a digital video asset. An audio clip to be associated with a portion of the video timeline can then be identified 404.

Next, a decision 406 can determine whether a video frame overlay viewer has been requested. There are various different implementations that allow a video frame overlay viewer to be requested. In one implementation, a key stroke command can be utilized to request the video frame overlay viewer. In another implementation, the video frame overlay viewer can be requested by a particular user gesture with respect to an input device. In still another embodiment, the video frame overlay viewer can be automatically requested (without user action) when a user has interacted with an audio association window, such as the audio association window 100 illustrated in FIG. 1, to identify an audio clip that is to be placed with respect to the video timeline.

In any event, when the decision 406 determines that a video frame overlay viewer has been requested, the video frame overlay viewer can be displayed 408 at a default location. The video frame overlay window can thus be automatically displayed 408 at the default location. The video frame overlay viewer can, for example, pertain to the multipoint video pane 114 illustrated in FIG. 1 or the multipoint video pane 200 illustrated in FIG. 2. The default location can be associated with the last position of the video frame overlay viewer when it was last utilized. Alternatively, the default location for the video frame overlay window can be near a working area. For example, the working area can be proximate to the position of an audio clip being associated with the video timeline. For example, as shown in FIG. 1, the video frame overlay view 114 can be placed proximate to the audio clip 112 so as to facilitate user interaction with its current task of placing the audio clip 112 at the proper location with respect to the video timeline.

In addition, first and second reference indicators can be displayed 410. In one implementation, the first and second reference indicators are displayed 410 across or with reference to the video timeline. Further, first and second reference video frames that respectively correspond to the position of the first and second reference indicators relative to the video timeline can be displayed 412. The video frame overlay viewer typically includes at least first and second video display regions. Hence, the first and second reference video frames are respectively displayed 412 in first and second video display regions of the video frame overlay viewer. The first and second reference indicators can be moved (e.g., as a group) relative to the video timeline, such as during a review or playback of a portion of the video, and consequently the first and second reference video frames being displayed 412 would update. In addition, when displaying 412 the first and second reference video frames, metadata corresponding to the first and second reference video frames can also be displayed.

Next, a decision 414 determines whether a third video frame is requested. In this embodiment, the video frame overlay viewer initially displays the first and second reference video frames. However, a user can request to display a particular third video frame. When the decision 414 determines that a third video frame has been requested, a third reference indicator can be displayed 416. In addition, a third reference video frame can be displayed 418. The third reference video frame can correspond to the position of the third reference indicator with respect to the video timeline. Additionally, metadata associated with the third reference video frame can also be displayed. In one implementation, the third reference video frame is presented in the video frame overlay viewer in a middle position, such as the video display region 206 illustrated in FIG. 2. In such an embodiment, the third reference indicator would be a reference indicator that is displayed between the first and second reference indicators for the respective video timeline. The third reference indicator can correspond to a cursor position. Alternatively, the third reference indicator can correspond to a synchronization point. A synchronization point can refer to a marker placed in or associated with a media file to specify a specific moment in time.

Following the block 418 or directly following the decision 414 when a third video frame is not being requested, a decision 420 determines whether a reference indicator has been repositioned. When the decision 420 determines that one of the reference indicators has been re-positioned, the reference indicator can be re-displayed 422 at its new position. Further, the video frame corresponding to the position of the re-positioned reference indicator can be determined and displayed 424.

Following the block 424, or directly following the decision 420 when a reference indicator has not been re-positioned, a decision 426 determines whether the video frame overlay viewer has been re-positioned. In one embodiment, the video frame overlay viewer is a floating pane (or window) that can be positioned through a drag and drop operation by user interaction with a user input device, such as a pointing device. When the decision 426 determines that the video frame overlay viewer has been re-positioned, the video frame overlay viewer is re-displayed 428 at its new location. In one embodiment, the video frame overlay viewer is partially translucent, so that the video frame overlay viewer can be utilized, e.g., displayed, over other graphical user interface components without completely obscuring such other user interface components.

Following the block 428, or directly following the decision 426 when the video frame overlay viewer has not been re-positioned, a decision 430 determines whether the video frame overlay viewer is to be closed. There are various different implementations that allow a video frame overlay viewer to be closed. In one implementation, a key stroke command can be utilized to initiate closure of the video frame overlay viewer. In another implementation, the user can close the dialog or window for the video frame viewer. In another implementation, an application program performing the audio association process 400 can initiate closure of the video frame overlay viewer. In still another embodiment, the video frame overlay viewer could be provided in a transient manner, whereby a user can press and hold a key to display the video frame overlay viewer but once the key is released the video frame overlay viewer can be removed. In any case, when the decision 430 determines that the video frame overlay viewer is to be closed, the display of the video frame overlay viewer is removed 432.

Following the block 432, or directly following the decision 430 when the video frame overlay viewer is not to be closed, a decision 434 can determine whether the audio clip has been placed in its desired location with respect to the video timeline. When the decision 434 determines that the audio clip has not been placed, then the audio association process 400 can return to repeat the decision 406 and subsequent blocks so that the user can continue to interact and utilize the video frame overlay viewer to assist the user in placing the audio clip with respect to the video timeline. Alternatively, when the decision 434 determines that the audio clip has been placed, the position of the audio clip relative to the video timeline can be saved 436. Thereafter, a decision 438 determines whether there are more audio clips to be placed. When the decision 438 determines that there are more audio clips to be placed, the audio association process 400 returns to repeat the block 404 and subsequent blocks so that another audio clip can be identified and similarly processed. On the other hand, once the decision 438 determines that there are no more audio clips to be placed, the display of the video frame overlay window together with any reference indicators can be removed 440. Following the block 440, the audio association process 400 can end.

Although FIGS. 1, 2, 3 and 4A-4C indicate use of two or three reference indicators and/or video frames, it should be understood that additional reference indicators and/or video frames can be utilized. It should also be noted that the references indicators can be hidden from display by a user command (e.g., key command or menu command).

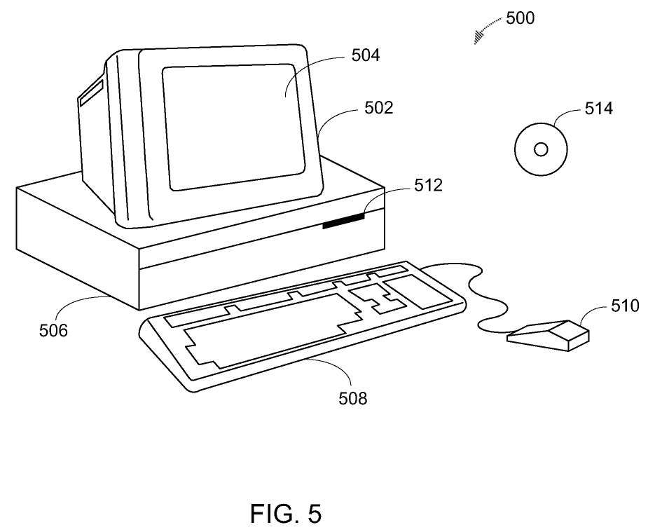

FIG. 5 shows an exemplary computer system 500 suitable for use with the invention. The methods, graphical user interfaces and/or computer apparatus discussed above can be provided by a computer system. The computer system 500 includes a display monitor 502 having a single or multi-screen display 504 (or multiple displays), a cabinet 506, a keyboard 508, and a mouse 510. The cabinet 506 houses a processing unit (or processor), system memory and a hard drive (not shown). The cabinet 506 also houses a drive 512, such as a DVD, CD-ROM or floppy drive. The drive 512 can also be a removable hard drive, a Flash or EEPROM device, etc. Regardless, the drive 512 may be utilized to store and retrieve software programs incorporating computer code that implements some or all aspects of the invention, data for use with the invention, and the like. Although CD-ROM 514 is shown as an exemplary computer readable storage medium, other computer readable storage media including floppy disk, tape, Flash or EEPROM memory, memory card, system memory, and hard drive may be utilized. Additionally, a data signal embodied in a carrier wave (e.g., in a network) may be the computer readable storage medium. In one implementation, a software program for the computer system 500 is provided in the system memory, the hard drive, the drive 512, the CD-ROM 514 or other computer readable storage medium and serves to incorporate the computer code that implements some or all aspects of the invention.

The various aspects, features, embodiments or implementations of the invention described above can be used alone or in various combinations.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that a particular point in time within a collection of video frames can be identified. The identification of the particular point allows a user to align an audio clip with the particular point in the collection of video frames. Another advantage of the invention is that a plurality of video frames can be concurrently presented to a user which assists the user in locating the particular point in time. Still another advantage of the invention is that the plurality of video frames can be presented as needed (as well as removed when not needed), automatically or on user request. Yet still another advantage of the invention is that the plurality of video frames can be presented proximate to a work location where the review of the video frames is expected to be needed.

U.S. patent application Ser. No. ______, filed concurrently, and entitled “MULTI-TAKE COMPOSTING OF DIGITAL MEDIA ASSETS,” is hereby incorporated herein by reference.

U.S. Provisional Patent Application No. ______, filed concurrently, and entitled “MULTIPLE VERSION MERGE FOR MEDIA PRODUCTION,” is hereby incorporated herein by reference.

U.S. Provisional Patent Application No. ______, filed concurrently, and entitled “TECHNIQUES AND TOOLS FOR MANAGING ATTRIBUTES OF MEDIA CONTENT,” is hereby incorporated herein by reference.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A graphical user interface, comprising:
a timeline for a digital video asset including a series of video frames;
at least one audio track region for associating one or more audio segments to the digital video asset;
a first reference indicator related to the timeline for the digital video asset;
a second reference indicator related to the timeline for the digital video asset; and
a video frame overlay viewer configured to concurrently present a plurality of video frames, the video frames including at least a first video frame and a second video frame, the first video frame being a particular one of the video frames from the digital video asset that corresponds to the first reference indicator, and the second video frame being a particular one of the video frames from the digital video asset that corresponds to the second reference indicator.

2. A graphical user interface as recited in claim 1, wherein the first reference indicator extends across said at least one audio track.

3. A graphical user interface as recited in claim 1, wherein the first reference indicator extents across said at least one audio track with reference to the timeline.

4. A graphical user interface as recited in claim 1, wherein an audio segment can be dragged and dropped onto the audio track region.

5. A graphical user interface as recited in claim 1, wherein the video frame overlay viewer is at least partially translucent.

6. A graphical user interface as recited in claim 1, wherein the first reference indicator and the second reference indicator are repositionable based on a user input.

7. A graphical user interface as recited in claim 1,
wherein the first reference indicator is repositionable based on a user input, and
wherein as the first reference indicator is repositioned, the first video frame is updated to include the particular one of the video frames from the digital video asset that corresponds to the first reference indicator as repositioned.

8. A graphical user interface as recited in claim 1, wherein at least one of the one or more audio segments is a sound effect clip to be associated to the digital video asset.

9. A graphical user interface as recited in claim 1, wherein said video frame overlay viewer further presents metadata for the first video frame and the second video frame.

10. A graphical user interface as recited in claim 9, wherein the metadata for the first video frame comprises a time code for video position of the first video frame, and wherein the metadata for the first video frame comprises a time code for video position of the second video frame.

11. A graphical user interface as recited in claim 1, wherein said graphical user interface further comprises a third reference indicator on the timeline for the digital video asset, and
wherein said video frame overlay viewer further presents a third video frame, the third video frame being a particular one of the video frames from the digital video asset that corresponds to the third reference indicator.

12. A method for displaying video frames of a digital video asset, said method comprising:
displaying a timeline for the digital video asset;
displaying a first reference indicator on the timeline for the digital video asset;
displaying a second reference indicator on the timeline for the digital video asset; and
displaying a video frame overlay viewer having a plurality of video frames being displayed, the video frames including at least a first video frame and a second video frame, the first video frame being a particular one of the video frames from the digital video asset that corresponds to the first reference indicator, and the second video frame being a particular one of the video frames from the digital video asset that corresponds to the second reference indicator.

13. A method as recited in claim 12, wherein the video frame overlay viewer is at least partially translucent.

14. A method as recited in claim 12, wherein the video frame overlay viewer further comprises metadata for the first video frame and the second video frame.

15. A method as recited in claim 14, wherein the metadata comprises a time code for video position of the first video frame and a time code for video position of the second video frame.

16. A method as recited in claim 12, wherein said method further comprises:
repositioning at least one of the first reference indicator and the second reference indicator.

17. A method as recited in claim 16, wherein said repositioning is based on a user input.

18. A method as recited in claim 17, wherein the position of the first reference indicator and/or the second reference indicator can be determined by a user.

19. A method as recited in claim 12, wherein said method further comprises:
displaying a third reference indicator on the timeline for the digital video asset,
wherein the video frames of said video frame overlay viewer further includes a third video frame, the third video frame being a particular one of the video frames from the digital video asset that corresponds to the third reference indicator.

20. A method as recited in claim 19, wherein the placement of the third reference indicator on the video display timeline is based on user selection.

21. A method as recited in claim 20, wherein the user selection is provided via a user interaction with a user input device.

22. A method as recited in claim 19, wherein the third reference indicator is provided between the first reference indicator and the second reference indicator.

23. A method as recited in claim 12, wherein said displaying of the video frame overlay viewer comprises:
determining a last used position for the video frame overlay viewer; and
displaying the video frame overlay viewer at the last used position.

24. A method as recited in claim 12, wherein said displaying of the video frame overlay viewer comprises:
determining a portion of an audio track that is being positioned with respect to the timeline; and
displaying the video frame overlay viewer proximate to the determined portion of the audio track.

25. A method as recited in claim 12, wherein said displaying of the video frame overlay viewer comprises:
determining a default location for the video frame overlay viewer; and
displaying the video frame overlay viewer at the default location.

26. A computer readable medium including at least computer program code for displaying video frames of a digital video asset, said computer readable medium comprising:
computer program code for displaying a timeline for the digital video asset;
computer program code for displaying a first reference indicator on the timeline for the digital video asset;
computer program code for displaying a second reference indicator on the timeline for the digital video asset; and
computer program code for displaying a video frame overlay viewer having a plurality of video frames being displayed, the video frames including at least a first video frame and a second video frame, the first video frame being a particular one of the video frames from the digital video asset that corresponds to the first reference indicator, and the second video frame being a particular one of the video frames from the digital video asset that corresponds to the second reference indicator.

27. A computer readable medium as recited in claim 26, wherein said computer readable medium further comprises:
computer program code for repositioning at least one of the first reference indicator and the second reference indicator.

28. A computer readable medium as recited in claim 26, wherein the video frame overlay viewer further comprises computer program code for displaying metadata for at least one of the first video frame or the second video frame.

29. A computing apparatus, comprising:
a display device capable of displaying a user interface;
a data storage device configured to store a digital video asset; and
a processing device operatively connected to said display device and said data storage device, said processing device being configured to at least present a video frame overlay viewer having a plurality of video frames that are concurrently displayed, the video frames including at least a first video frame and a second video frame, the first video frame being a particular one of the video frames from the digital video asset that corresponds to a first reference indicator, and the second video frame being a particular one of the video frames from the digital video asset that corresponds to a second reference indicator.
